(19) United States
(12) Patent Application Publication
(10) Pub. No.: US 2012/0312189 A1
(43) Pub. Date: Dec. 13, 2012

(54) INTERNAL COMBUSTION ENGINE CONSTITUENT MEMBER, AND FORMATION METHOD FOR WATER/OIL REPELLENT COATING FILM

(75) Inventors: Takeshi Bessho, Toyota-shi (JP); Satoshi Takata, Toyota-shi (JP)

(73) Assignee: TOYOTA JIDOSHA KABUSHIKI KAISHA, Toyota-shi, Aichi-ken (JP)

(21) Appl. No.: 13/579,694

(22) PCT Filed: Feb. 14, 2011
(86) PCT No.: PCT/IB2011/000269

§ 371 Date: Aug. 17, 2012

(30) Foreign Application Priority Data
Feb. 25, 2010 (JP) 2010-039936

(51) Int. Cl. C09K 3/18; C09D 5/00

(52) U.S. Cl. 106/2

(57) ABSTRACT

An internal combustion engine constituent member of the invention has on its surface a water/oil repellent coating film that is formed from a solution that contains a fluoroalkyl group-substituted metal alkoxide that is represented by a general formula: Rfₘ-M(OR¹)ₙ₋ₘ where Rf is a fluoroalkyl group represented by a formula: CF₃—(CF₂)₃—R² (where R² is each of alkylene groups that have a carbon number of 2 to 10, and that are the same as or different from each other), and m is the number of the fluoroalkyl groups, and M is a metal atom, and R¹ is each of alkyl groups that have a carbon number of 1 to 5, and that are the same as or different from each other, and n is a valence of the metal atom M.

### BACKGROUND OF THE INVENTION

1. Field of the Invention

The invention relates to a constituent member for an internal combustion engine, and a formation method for a water/oil repellent coating film. More particularly, the invention relates to a method of forming a highly durable water-repellent and oil-repellent coating film on a surface of a constituent member for an internal combustion engine, such as a cylinder head, piston heads, fuel injection valves, etc., and to an internal combustion engine constituent member provided with a water/oil repellent coating film.

2. Description of the Related Art

The fuel injection valves of internal combustion engines need to certainly shut off fuel or control the amount of flow of fuel by opening and closing their valves. Usually, the fuel contains undesired substances, such as oils, additives, water, etc. These substances become deposited on the fuel injection valves and particularly on injection hole portions, forming deposited material called deposit. Even if a fuel injection valve is constructed with high precision, the presence of deposits will impede the flow of fuel or the like, and may possibly prevent the fuel injection system from fully performing its function. Besides, in the combustion chambers of an internal combustion engine, deposits also attach to a wall surface during a long time of use. The deposits wear the cylinder liners, so that oil leakage occurs and the consumption of the engine oil increases. Furthermore, soot becomes thermally adhered to the wall surfaces of the combustion chambers, and fuel attaches in a wet state to the soot adhered to the wall surfaces. In consequence, there occurs a problem of increases in the amount of unburnt hydrocarbon and soot.

To solve the foregoing problems, technologies of restraining the attachment of deposits on surfaces of constituent members of an internal combustion engine, such as the fuel injection valves and the like, by performing a water/oil repelling treatment on the surfaces of the constituent members have been proposed. For example, Japanese Patent Application Publication No. 7-246365 (JP-A-7-246365)) discloses a method in which a metal alkoxide that contains aluminum alkoxide and a fluoroalkyl group-substituted metal alkoxide in which the alkoxyl groups are partly substituted with fluoroalkyl groups are mixed to form a solution, and the solution is applied to internal surfaces of combustion chambers of an internal combustion engine which are made of aluminum or an aluminum alloy, and is fired to form a coating film thereon.

Japanese Patent Application Publication No. 10-159687 (JP-A-10-159687)) discloses a fuel injection valve of an in-cylinder injection internal combustion engine characterized in that the fuel injection valve has a coating film that is formed from a mixed solution of a metal alkoxide and a fluoroalkyl group-substituted metal alkoxide and that has a film thickness of 10 nm to 100 nm, and in that the concentration of fluoroalkyl group-substituted metal alkoxide in the mixed solution is 5 to 20 mol % relative to the total amount of alkoxide. This technology is intended to heighten the endurance to high temperature and explosion pressure by limiting the film thickness of the coating film and the concentration of fluoroalkyl group-substituted metal alkoxide within predetermined ranges of thickness and concentration. Besides, the fluoroalkyl group is represented by a formula: CF₃(CF₂)ₓ—C₂H₄—, where x is preferred to be 5 to 10.

However, perfluorooctanic acid that is a raw material of the foregoing fluoroalkyl group-substituted metal alkoxide (a raw material in the case of x=7) is presently regulated; more specifically, its sale has been stopped in Japan since the end of 2009, and it has been determined that perfluorooctanic acid will be totally abolished worldwide in 2015. Besides, perfluorohexanic acid (a raw material in the case of x=5) may also possibly be banned from use. Therefore, there has been a demand for development of an alternative technology for forming a coating film that has good water/oil repellency and is able to restrain attachment of deposits to the coating film.

### SUMMARY OF THE INVENTION

The invention provides a constituent member for an internal combustion engine which has a water/oil repellent coating film that is high in the deposit attachment restraining capability, and a method for forming the coating film.

Through considerations, the present inventors have found that the foregoing problems can be solved by optimizing the structure of fluoroalkyl groups, and therefore have completed the invention.

A first aspect of the invention relates to an internal combustion engine constituent member whose surface has a water/oil repellent coating film that is formed from a solution that contains a fluoroalkyl group-substituted metal alkoxide that is represented by a general formula: Rfₘ-M(OR¹)ₙ₋ₘ where Rf is a fluoroalkyl group represented by a formula: CF₃—(CF₂)₃—R² (where R² is each of alkylene groups that have a carbon number of 2 to 10, and that are the same as or different from each other), and m is the number of the fluoroalkyl groups, and M is a metal atom, and R¹ is each of alkyl groups that have a carbon number of 1 to 5, and that are the same as or different from each other, and n is a valence of the metal atom M.

The metal atom M may be a silicon atom.

An F/Si ratio (molar ratio) in a surface of the water/oil repellent coating film measured by an X-ray photoelectron spectroscopic method (XPS) may be greater than or equal to 0.6.

A second aspect of the invention relates to a formation method for a water/oil repellent coating film which includes: applying to a surface of an internal combustion engine constituent member a solution that contains a fluoroalkyl group-substituted metal alkoxide that is represented by a general formula: Rfₘ-M(OR¹)ₙ₋ₘ where Rf is a fluoroalkyl group represented by a formula: CF₃—(CF₂)₃—R² (where R² is each of alkylene groups that have a carbon number of 2 to 10, and which are the same as or different from each other), and m is the number of the fluoroalkyl groups, and M is a metal atom, and R¹ is each of alkyl groups that have a carbon number of 2 to 10, and that are the same as or different from each other), and m is the number of the fluoroalkyl groups, and M is a metal atom, and R¹ is each of alkyl groups that have a carbon number of 1 to 5, and that are the same as or different from each other, and n is a valence of the metal atom M; and firing the solution applied to the surface.

The metal atom M may be a silicon atom.

Concentration of the fluoroalkyl group-substituted metal alkoxide may be greater than or equal to 7 mol % and less than or equal to 100 mol % relative to an entire amount of metal alkoxides in the solution.

According to the invention, on an internal combustion engine constituent member, such as a fuel injection valve or the like, it is possible to achieve the deposit attachment restraining effect at a high degree by forming a coating film from a solution that contains a specific fluoroalkyl group-substituted metal alkoxide. Incidentally, the metal M of the invention includes semimetal.

### BRIEF DESCRIPTION OF THE DRAWINGS

The features, advantages, and technical and industrial significance of this invention will be described below with reference to the accompanying drawings, in which like numerals denote like elements, and wherein:

FIG. 1 is a graph showing a relation between the F/Si ratio of a water/coil repellent coating film surface and the water contact angle; and

FIG. 2 is a graph showing a relation between the concentration of a fluoroalkyl group-substituted metal alkoxide and the water contact angle.

### DETAILED DESCRIPTION OF EMBODIMENTS

In an embodiment of the invention, a solution for forming a water/oil repellent coating film contains a fluoroalkyl group-substituted metal alkoxide that is represented by a general formula (1): Rfₘ-M(OR¹)ₙ₋ₘ. In the foregoing formula, Rf is a fluoroalkyl group represented by a formula: CF₃—(CF₂)₃—R² where R² is each of alkylene groups that have a carbon number of 2 to 10, such as CH₂CH₂, CH₂CH₂CH₂, etc., and that are the same as or different from each other. Besides, m is the number of the fluoroalkyl groups, and M is a metal atom, and R¹ is each of alkyl groups that have a carbon number of 1 to 5 and which are the same as or different from each other, and n is a covalence of a metal atom M. The presence of a fluoroalkyl group provides the coating film with water/oil repellency, and effectively restrains the attachment of deposits to the coating film.

As for the metal atom M, various metal atoms can be used, and a metal atom that corresponds to an intended metal oxide is used. Examples of the metal include but are not limited to Li, Na, Cu, Ca, Sr, Ba, Zn, B, Al, Ga, Y, Si, Ge, Pb, Sb, V, Ta, W, La, Nd, etc. A preferable metal herein is Si. Besides, as for the alkyl group having a carbon number of 1 to 5 which is represented by R¹, either of a straight chain type or a branched chain type may be applied. Concrete examples of the alkyl group include a methyl group, an ethyl group, a propyl group, an isopropyl group, etc.

The greater the number of the fluoroalkyl groups, that is, the greater the number m of Rf in the general formula (1), the higher the water/oil repellency becomes. However, if the number m of the fluoroalkyl groups is excessively great, the fluoroalkyl groups may sometimes become unable to closely align on a surface of the coating film. Therefore, the balance in this respect is taken into account to appropriate set the number of the fluoroalkyl groups. Usually, it is preferable that the number m of the fluoroalkyl group be 1.

Concrete examples of the foregoing fluoroalkyl group-substituted metal alkoxide include but are not limited to CF₃(CF₂)₃C₂H₄Si(OCH₃)₃, CF₃(CF₂)₃C₂H₄Si(OC₂H₅)₃, etc.

The fluoroalkyl group-substituted metal alkoxide, which can be used alone as well, is usually preferred to be used in combination with a metal alkoxide that is represented by a general formula (2): M(OR¹)ₙ. It is to be noted herein that in the general formula (2), M, R¹ and n are as defined above. That is, examples of the metal alkoxide that can be used include but are not limited to Si(OCH₃)₄, Si(OCH₂CH₃)₄, etc. Since such a metal alkoxide is contained, high abrasion resistance and high peeling resistance of the coating film can be maintained.

The coating film on a surface of a constituent member for an internal combustion engine is formed through the use of a metal alkoxide as mentioned above, by a so-called sol-gel method. The sol-gel method is a method in which a solution of an organic or inorganic compound is solidified from a sol form to a gel form by causing a hydrolysis-polycondensation reaction of the organic or inorganic compound to progress, and the gel is applied to a substrate and then is heated to form a coating film.

Concretely, a solution for forming a coating film is prepared by adding water (for the hydrolysis), alcohol (for preparing a homogeneous solution), an acid or base (for catalytic action) to the fluoroalkyl group-substituted alkoxide and the metal alkoxide. Examples of the alcohol used herein include methanol, ethanol, propanol, butanol, etc. Examples of the acid that is used as a catalyst include hydrochloric acid, sulfuric acid, acetic acid, and fluoric acid. As the base, ammonium may be used as it can be removed by volatilization after the process has been performed. Besides, an additive known in conjunction with the sol-gel method, for example, acetyl acetone or the like, may be added into the solution.

The larger the amount of the fluoroalkyl group-substituted metal alkoxide in the solution, the higher the water/oil repellency becomes and the more the deposit attachment restraining effect improves. However, it is to be noted that if the amount of the fluoroalkyl group-substituted metal alkoxide in the solution is excessively large, the coating film may sometimes have nonuniformity. Concretely, the concentration of the fluoroalkyl group-substituted metal alkoxide is preferred to be greater than or equal to 7 mol % and less than or equal to 100 mol % and, particularly, greater than or equal to 10 mol % and less than or equal to 50 mol % relative to the entire amount of metal alkoxides in the solution, that is, the total amount of the fluoroalkyl group-substituted metal alkoxide and the other metal alkoxides in the solution.

The prepared solution is stirred at a predetermined temperature, and is aged according to need, so as to cause the hydrolysis-polycondensation reaction of the metal alkoxide to progress so that the solution is made into a gel form. Then, a constituent member for an internal combustion engine is dipped in the gel-form solution, whereby a wet coating film is formed on surfaces of the constituent member.

The constituent member for an internal combustion engine concerned herein is any constituent member as long as there is possibility of deposits attaching to the constituent member. Besides, the solution prepared as described above may be applied to the entire surfaces of the member or a portion thereof. Examples of a surface of the constituent member for an internal combustion engine include surfaces of a piston head and a cylinder head, an internal wall of a fuel injection hole of a fuel injection valve, an internal wall of a combustion chamber, etc.

When a wet coating film is formed, the film thickness to be obtained can be adjusted by adjusting the amount of a solvent of the solution and particularly the amount of alcohol in the solution. If the film thickness of the coating film is excessively small, the heat resistance of the coating film may sometimes decline. On the other hand, if the film thickness is excessively large, the peeling resistance of the coating film may sometimes deteriorate so that, for example, the coating film cannot withstand the injection pressure of the fuel injected from the injection hole, and may peel. Therefore, this is taken into account to appropriately set the film thickness of the coating film. Concretely, the film thickness of the coating film is preferred to be 10 nm to 100 nm and particularly 20 nm to 80 nm.

Finally, the wet coating film is fired. Usually, prior to the firing step, a drying process of removing water and the solvent is performed. In the drying step, fluoroalkyl groups are concentrated to the surface of the coating film. As a result, many fluoroalkyl groups are caused to exist at or near the surface of the coating film obtained, which greatly contributes to improved water/oil repellency. Incidentally, the firing step can be performed according to a common method in the sol-gel methods, and is generally performed by heating at 200° C. to 500° C. in the atmosphere or in a non-oxidative atmosphere. In the case where the firing is performed in the atmosphere, it is preferable to perform the firing at 350° C. or lower in order to prevent decomposition of fluoroalkyl groups. In this manner, a water/oil repellent coating film can be formed on a surface of the constituent member for an internal combustion engine.

Besides, in the case where the metal atom M in the fluoroalkyl group-substituted alkoxide and the metal alkoxide is Si, it is preferable that the F/Si ratio (molar ratio) measured by an X-ray photoelectron spectroscopic method (XPS) be greater than or equal to 0.6. If the F/Si ratio is greater than or equal to 0.6, the water/oil repellency becomes high and the effect of restraining the attachment of deposits becomes great.

Hereinafter, the invention will be further described in detail with reference to concrete examples and reference examples, to which the invention is not limited.

### EXAMPLE 1

An SUS was prepared as a substrate for the coating, and was subjected to ultrasonic cleaning Subsequently, the components shown in table 1 were placed into 100 ml-screw cap tubes. After being capped, the 100 ml tubes were subjected to the stirring at 25° C. for 24 hours to prepare a solution for forming a coating film. Incidentally, the concentration of the fluoroalkyl group-substituted metal alkoxide CF₃(CF₂)₃C₂H₄Si(OCH₃)₃ in the solution corresponded to 7 mol % of the entire amount of metal alkoxides in the solution. The SUS substrate was dipped into the solution, and was slowly lifted therefrom to form a wet coating film on surfaces of the SUS substrate. Subsequently, the wet coating film was fired at 200° C. for 1 hour to form an intended water/oil repellent coating film. The coated SUS substrate obtained as described above was subjected to the measurement of the water contact angle. Results of the measurement are shown in Table 3. It is said that the critical value of the water contact angle for obtaining the effect of restraining the attachment of deposits is 90°. The water contact angle of the coating film of Example 1 was 91°, and the coating film of Example 1 exhibited substantially the same performance as Reference Example 1 described below. Thus, the coating film of Example 1 was found to be effective in restraining the attachment of deposits.

### Reference Example 1

The formation of a coating film on an SUS substrate and the measurement of the water contact angle were performed substantially the same manner as in Example 1, except that the solution was prepared by using components shown in Table 2. Results are shown in Table 3. While the critical value of the water contact angle that achieves the deposit attachment restraining effect is said to be 90°, the water contact angle of the coating film of Reference Example 1 was 92°.

TABLE 1
Composition of Solution in Example 1

| Component | Weight (g) |
|---|---|
| CF₃(CF₂)₃C₂H₄Si(OCH₃)₃ | 1.4 |
| Si(OC₂H₅)₄ | 11.6 |
| Hydrochloric acid (0.05N) | 12 |
| Ethanol | 40 |

TABLE 2
Composition of Solution in Reference Example 1

| Component | Weight (g) |
|---|---|
| CF₃(CF₂)₇C₂H₄Si(OCH₃)₃ | 0.6 |
| Si(OC₂H₅)₄ | 12 |
| Hydrochloric acid (0.05N) | 12 |
| Ethanol | 40 |

TABLE 3
Results of Measurement of Water Contact Angle

| | Fluoroalkyl group-substituted | |
|---|---|---|
| | metal alkoxide | Water contact angle (°) |
| Example 1 | CF₃(CF₂)₃C₂H₄Si(OCH₃)₃ | 91 |
| Ref. Ex. 1 | CF₃(CF₂)₇C₂H₄Si(OCH₃)₃ | 92 |

### EXAMPLE 2

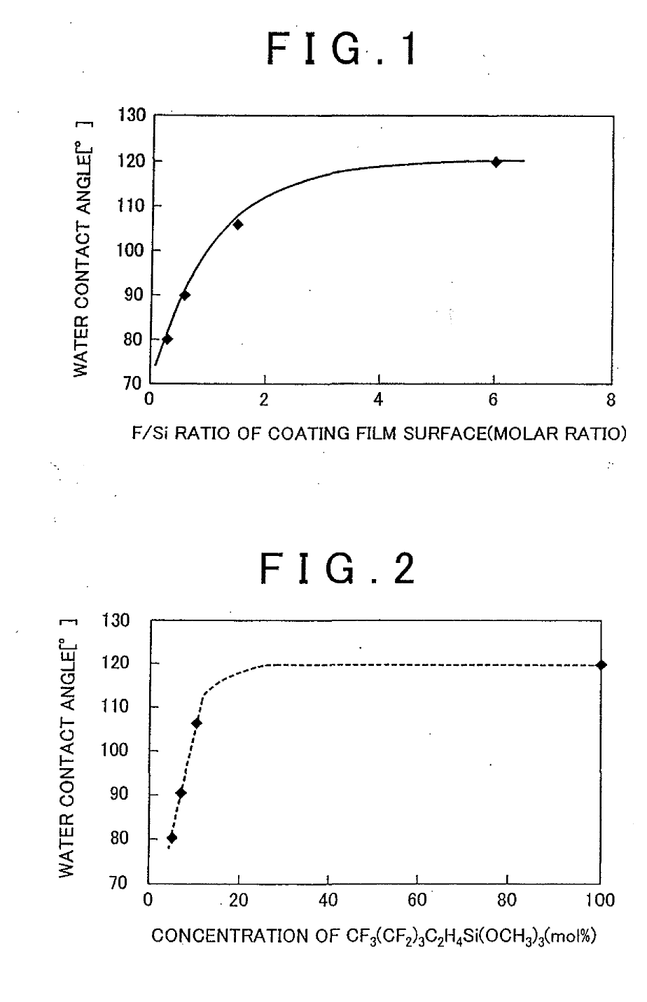

A coating film was formed on an SUS substrate in substantially the same manner as in Example 1 described above, except that the solution was prepared by using the components shown in Table 4. Then, with regard to the SUS substrate with the water/oil repellent coating film, the F/Si ratio of the coating film surface was found by the X-ray photoelectron spectroscopic method (XPS), and the water contact angle was measured. Incidentally, the measurement by the XPS was performed by using an ESCA 1600 device made by Ulvac-phi, Inc., in an X-ray production condition of 14 kV-350 W. A relation between the F/Si ratio of the coating film surface and the water contact angle is shown in FIG. 1. As is apparent from FIG. 1, it has been found that the water contact angle becomes larger than 90° when the F/Si ratio of the coating film surface is in the range of 0.6 and higher.

TABLE 4
Composition of Solution in Example 2

| Component | Weight (g) |
|---|---|
| CF₃(CF₂)₃C₂H₄Si(OCH₃)₃ | 1 to 13 |
| Si(OC₂H₅)₄ | 0-12 |
| Hydrochloric acid (0.05N) | 12 |
| Ethanol | 40 |

Furthermore, a relation between the water contact angle and the concentration of the fluoroalkyl group-substituted metal alkoxide CF₃(CF₂)₃C₂H₄Si(OCH₃)₃ relative to the entire amount of metal alkoxides in the solution is shown in FIG. 2. As is apparent from FIG. 2, it has been found that the water contact angle becomes larger than 90° when the concentration of CF₃(CF₂)₃C₂H₄Si(OCH₃)₃ is in the range of 7 mol % and higher.

1. An internal combustion engine constituent member whose surface has a water/oil repellent coating film that is formed from a solution that contains a fluoroalkyl group-substituted metal alkoxide that is represented by a general formula: Rfₘ-M(OR¹)ₙ₋ₘ where Rf is a fluoroalkyl group represented by a formula: CF₃—(CF₂)₃—R² (where R² is each of alkylene groups that have a carbon number of 2 to 10, and that are the same as or different from each other), and m is the number of the fluoroalkyl groups, and M is a metal atom, and R¹ is each of alkyl groups that have a carbon number of 1 to 5, and that are the same as or different from each other, and n is a valence of the metal atom M.

2. The internal combustion engine constituent member according to claim 1, wherein
the metal atom M is a silicon atom.

3. The internal combustion engine constituent member according to claim 2, wherein
an F/Si ratio (molar ratio) in a surface of the water/oil repellent coating film measured by an X-ray photoelectron spectroscopic method (XPS) is greater than or equal to 0.6.

4. A formation method for a water/oil repellent coating film comprising: applying to a surface of an internal combustion engine constituent member a solution that contains a fluoroalkyl group-substituted metal alkoxide that is represented by a general formula: Rfₘ-M(OR¹¹)ₙ₋ₘ where Rf is a fluoroalkyl group represented by a formula: CF₃—(CF₂)₃—R² (where R² is each of alkylene groups that have a carbon number of 2 to 10, and which are the same as or different from each other), and m is the number of the fluoroalkyl groups, and M is a metal atom, and R¹ is each of alkyl groups that have a carbon number of 1 to 5, and that are the same as or different from each other, and n is a valence of the metal atom M; and firing the solution applied to the surface.

5. The formation method according to claim 4, wherein
the metal atom M is a silicon atom.

6. The formation method according to claim 4 or 5, wherein
concentration of the fluoroalkyl group-substituted metal alkoxide is greater than or equal to 7 mol % and less than or equal to 100 mol % relative to an entire amount of metal alkoxides in the solution.
